(19) United States
(12) Patent Application Publication
(10) Pub. No.: US 2024/0379250 A1
(43) Pub. Date: Nov. 14, 2024

(54) BEAM-CATALYZED VOLUME IGNITION OF FUSION REACTIONS

(71) Applicant: HB11 Energy Holdings Pty Ltd, Freshwater NSW (AU)

(72) Inventors: Thomas A. Mehlhorn, Beaverton, OR (US); Warren McKenzie, Freshwater (AU)

(21) Appl. No.: 18/686,668

(22) PCT Filed: Aug. 26, 2022
(86) PCT No.: PCT/US2022/041732

§ 371 Date: Feb. 26, 2024

(51) Int. Cl. G21B 1/23; G21B 1/03; G21B 1/19

(52) U.S. Cl. CPC G21B 1/23; G21B 1/03; G21B 1/19

(57) ABSTRACT

A nuclear fusion device, comprising: a reaction chamber configured to house a fuel target; a compression laser array configured to irradiate and thereby compress the fuel target; an ion acceleration laser array configured to irradiate the fuel target, to ionize at least a portion of the fuel target and generate ions, to accelerate the ions through the fuel target, and to thereby ignite a nuclear fusion reaction; and an energy conversion module, configured to convert energy released by the nuclear fusion reaction into electricity.

### RELATED APPLICATIONS

This application claims the benefit of priority to U.S. Provisional Patent Application No. 63/237,260, filed 26 Aug. 2021

### BACKGROUND OF THE INVENTION

There are many approaches to fusion energy generation being pursued most of which are focused on thermal means whereby fuels are heated to many millions of degrees to achieve ignition. None have been successful in producing net-energy-gain. Some of these approaches include hot-spot-ignition, fast ignition, and shock ignition. Some have also used laser technology (nano-second pulses, herein referred to as long-pulse lasers) to achieve the conditions required to achieve fusion reactions via thermal means, including compression of the fuel to high density and heating. However, none have demonstrated net-energy gain using the most studied fuels, deuterium and tritium (DT).

For proton-boron-fusion, it has been broadly accepted in the field that ignition of the aneutronic proton-boron reaction at a laboratory scale by purely thermal mean is impractical given that the temperatures required are 10-100 times higher than for deuterium-tritium (DT) reaction.

### SUMMARY OF THE INVENTION

In one embodiment, the present invention is a nuclear fusion device, comprising a reaction chamber configured to house a fuel target; a compression laser array configured to irradiate and thereby compress the fuel target; an ion acceleration laser array configured to irradiate the fuel target, to ionize at least a portion of the fuel target and generate ions, to accelerate the ions through the fuel target, and to thereby ignite a nuclear fusion reaction; and an energy conversion module, configured to convert energy released by the nuclear fusion reaction into electricity.

In another example embodiment, the present invention is a nuclear fusion reaction fuel target, comprising at least hydrogen and boron-11 nuclear fusion reactant materials, wherein the fuel target is spherical, and wherein the fuel target is solid at room temperature.

In another example embodiment, the present invention is a nuclear fusion reaction fuel target, comprising a core comprising at least boron-11 and a second nuclear fusion reactant material, and a shell encapsulating the core, wherein the fuel target is solid at room temperature.

In another embodiment, the present invention is a nuclear fusion system comprising any of the nuclear fusion devices described herein; and any of the nuclear fusion reaction fuel targets described herein, disposed in the reaction chamber of the nuclear fusion device.

In another embodiment, the present invention is a method for producing a nuclear fusion reaction, comprising irradiating a fuel target housed in a reaction chamber with laser pulses generated by a compression laser array, thereby compressing the fuel target; irradiating the fuel target with laser pulses generated by an ion acceleration laser array, thereby ionizing at least a portion of the fuel target, generating ions, accelerating the ions through the fuel target, and thereby igniting the nuclear fusion reaction; and converting energy released by the nuclear fusion reaction into electricity.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a plot of representing an example of an energy spectrum of a laser-ion accelerated protons generated by the Texas petawatt laser facility.

FIG. 2 is a schematic diagram illustrating the methods described herein.

FIG. 3 is a plot showing fusion reaction cross-sections as a function of particle energy for deuterium-deuterium (DD), deuterium-tritium (DT), and proton-boron-11 (P-B11) reactions.

FIG. 4 is a plot of illustrating a beam-catalyzed hybrid pB11 burn reactivity space.

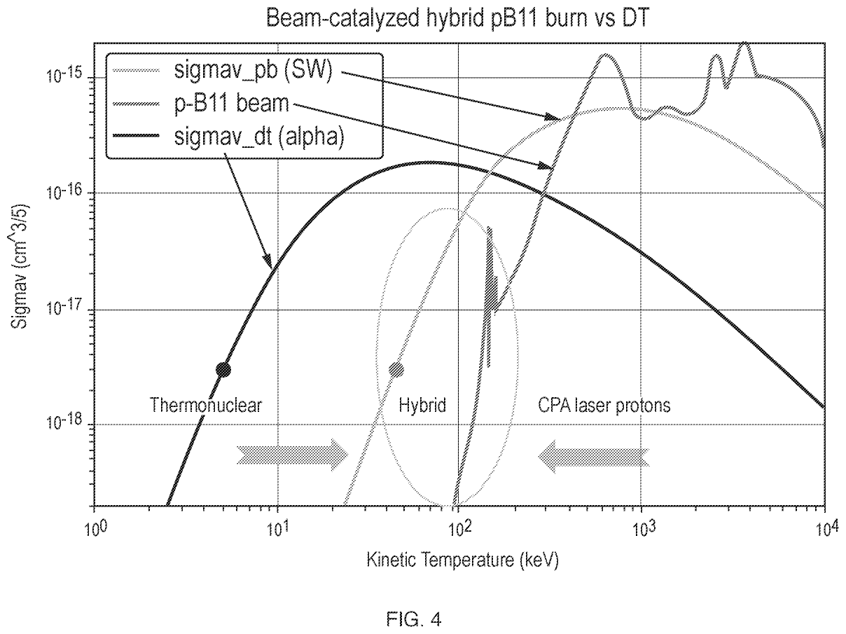

FIG. 5 is a plot showing the generation of a non-equilibrium fusion flame.

FIG. 6 is a plot generated by the same computer simulation used for FIG. 5 of the total fusion yield following a laser pulse of energy 4×10²⁰ W/cm² across wavelengths 0.25 μm (1), 0.50 μm (2) and 1 μm (3).

### DETAILED DESCRIPTION OF THE INVENTION

A description of example embodiments of the invention follows.

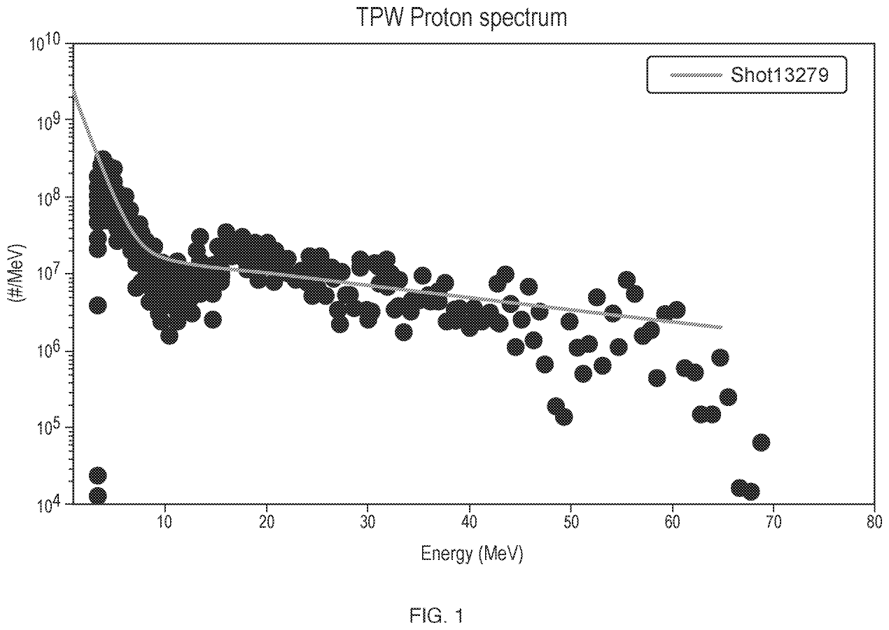

Fusion reactions have been achieved using non-thermal means, including proton boron-11 enabled by advances in high-peak-power laser technology. While most demonstrations have pulse lengths in the picoseconds (herein called a short-pulse laser) and below, a demonstration of such results from pulse lengths as high as 10 ns have been observed. These laser pulses enable efficient acceleration of ions to high energies. In experiment described herein, protons were accelerated up to tens of megaelectron-volts (MeV), an energy range impossible to reach using thermal means. An example of a laser-ion accelerated proton energy spectrum from one experiment is given in the FIG. 1. These protons were successful in producing high numbers of p11B reactions, which saw greater than 109 alpha-particles generated from an 80 Joules (J) laser pulse.

However, the analysis of the experimental data has shown that these reactions are generated in a beam-fusion regime. Beam-fusion reactions alone will not be sufficient in producing enough reactions to reach net-energy gain.

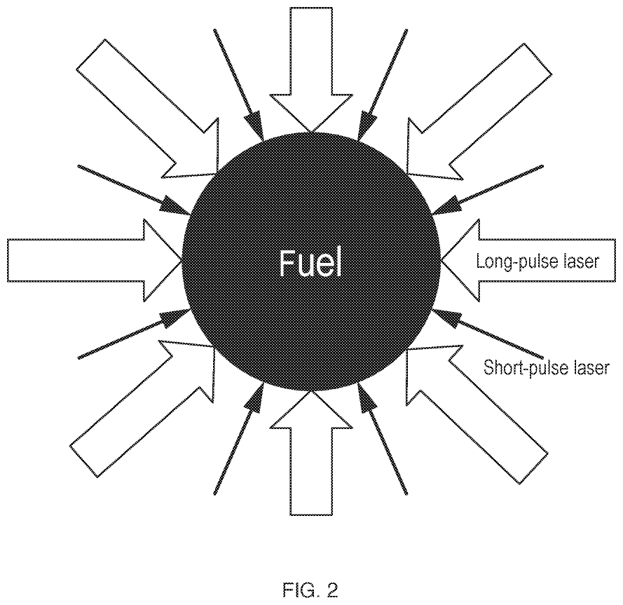

The devices and methods described herein involve a combination of thermal and non-thermal approaches generated by both short and long-pulse lasers, as outlined in FIG. 2. A fuel shaped as a sphere is irradiated by a long-pulse laser/s to isochorically (i.e. with a uniform density) implode a fuel to a high density nearly degenerate state. The short pulse laser/s are then used to accelerate high-energy protons from the coronal plasma near the surface of the fuel to generate beam-fusion reactions (and other non-thermal reactions from it) within an outer spherical shell whose thickness corresponds to the ion stopping range of the protons. A combination of electron and proton energy deposition, augmented by non-thermal beam-fusion reactions within this layer ignites a thermonuclear burn wave, which propagates into the core, akin to the “helium flash” of a low mass star. The conditions created by the combination of both lasers and the fusion reactions enable a non-equilibrium thermonuclear burn of the fuel capable of achieving reaction gains of a factor of at least 10 more than the laser pulse energy.

Unlike alternate schemes, such as hot-spot ignition, shock-ignition and fast ignition, the devices and methods described herein do not initiate a fusion burn exclusively via thermal mechanisms. A key feature of the disclosed devices and methods is that the burn is catalyzed by non-thermal beam fusion reactions from a high-energy ion beam using short-pulse lasers incident on the target. Other feature of this reaction is its application for the proton-boron-11 (p-11B) reaction, whereby the accelerated ions are protons, and, for a deuterium-tritium reaction, where the ions are deuterium.

In this regime, the amplification of the fusion reaction on the imploded fuel is caused by several key factors:
Conditions created by the long-pulse laser:
   Implosion of the fuel creating compression to many times its solid-state density providing a nearly degenerate fusion fuel into which a burn wave can be propagated.
Conditions created by the short-pulse laser:
   Acceleration of a large number of protons (plasma-block) from the ions in the fuel (or in a layer surrounding the fuel) that create non-thermal fusion reactions. The ions that are generated have a high kinetic energy and therefore can generate fusion reactions from the more reactive, higher energy regions of the cross-section than is possible with thermal means.
   Fast ions are generated by the laser. In the case of the p11B reaction, inflight fusion reactions also generate energetic alpha particles. Elastic collisions between fast ions and thermal protons in the fuel increase the likelihood of an avalanche multiplication of the reaction (also known as “Lift”).
   Heating of the fuel, by:
      Beam fusion reactions
      Directly from the laser (hot electrons)
      Stopping of the accelerated ions as they travel through the fuel.
Ignition of the outer fuel layer which launches a thermonuclear burn wave into the central fuel, as well as a shock wave as the outer layer functions as an exploding pusher.

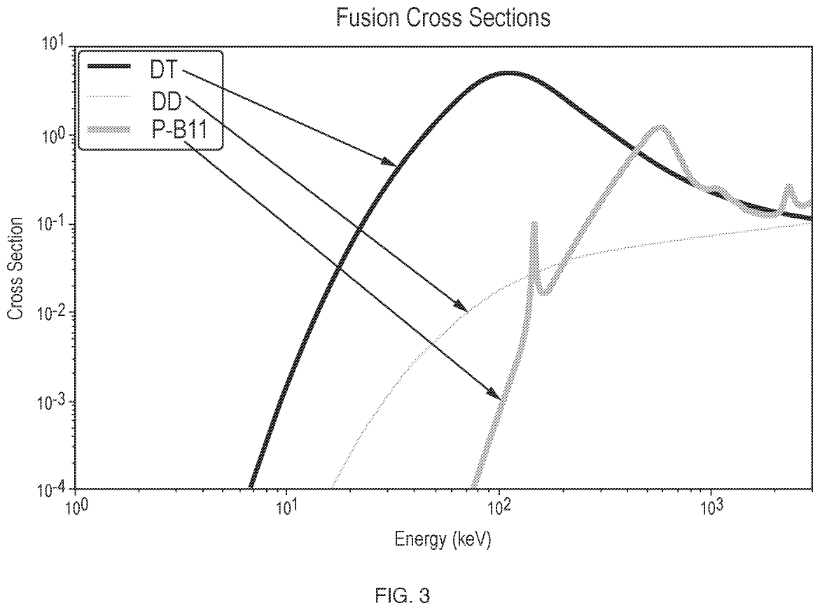

Referring to the cross-section of fusion reactions as a function of energy shown in FIG. 3, the high energy ions generated by the short pulse lasers will generate beam fusion reactions in the region above about 1 MeV, where all cross sections are relatively high. After this ignition, the mechanisms creating heat will increase the temperature of the fuels into the region where thermal fusion contributes to the burn, about 10 keV for DT fusion or 100 keV for p11B.

As the reaction rates are proportional to the density, the introduction of compression will further increase the reaction rates contributing to the burn.

In summary, the devices and methods disclosed herein include the following features: a laser fusion device; a fusion target; and a fusion system. A laser fusion device comprises:
a chamber, which can house a fuel target;
at least two arrays of lasers (wherein an “array” includes at least two lasers), with each laser directing energy towards the target position;
   an array of compression lasers—long-pulse (nanosecond or less) lasers used to compress the fuel to near Fermi degenerate densities;
   an array of ion acceleration lasers—short-pulse lasers generating beams of high energy (>1 MeV) ions. These ions could either be protons, deuterium, boron-11 or He-3;
an energy conversion device for converting the energy that is released during the nuclear fusion from the nuclei that are produced into electricity.
   Each of the laser arrays can include a large number (>10, >100 or even >1000) of diode-pumped lasers to achieve the conditions described to reach a fusion burn. Diode pumped lasers are capable of efficiently converting electricity into light. In the case of aneutronic reactions, these systems are practically viable as high energy neutrons generated would otherwise damage the diodes and limit their lifetimes. Excimer lasers (also called exciplex lasers, a commonly known form of ultraviolet laser) also can have sufficient efficiency.

The fusion target material and structure are envisioned as follows:
An approximately spherical fuel target, comprising:
   an outer layer, comprising a source of fusion ions, such as a polymer or implanted outer layer. For p11B this includes protons. For a p11B-D3He hybrid regime, this could include deuterium or 3He.
   A high atomic number layer, which promotes the acceleration of ions through the fuel limits thermal conduction and radiation losses from the fuel.
A core material, comprising the main fuel mixture with the fusion isotopes in a mixture chosen to minimize radiation production and to maximize catalyzing fusion reactions:
   In the case of p11B, includes an appropriate isotope mixture, which:
      Includes 11B and hydrogen;
      Includes a majority of hydrogen (measured by % weight), so as to limit radiation and thermal conduction losses from heat produced by the laser interactions and nuclear reactions.
The diameter of the sphere is approximately the range of the laser accelerated ions initially in the outer shell.

Other than containing the fusion fuels, the target is designed to limit radiation production and loss in the fuel through an appropriate mixture of fuel isotopes and use of a high atomic number coating material, which has two features. The first is to promote the mechanisms of laser ion acceleration to achieve high number and/or energy of protons accelerated through the fuel. The second is to limit radiation and thermal conduction losses from heat produced by the laser interactions and nuclear reactions.

Accordingly, in a first example embodiment, the present invention is a nuclear fusion device. In a 1^{st} aspect of the 1^{st} example embodiment, the device comprises a reaction chamber configured to house a fuel target; a compression laser array configured to irradiate and thereby compress the fuel target; an ion acceleration laser array configured to irradiate the fuel target, to ionize at least a portion of the fuel target and generate ions, to accelerate the ions through the fuel target, and to thereby ignite a nuclear fusion reaction; and an energy conversion module, configured to convert energy released by the nuclear fusion reaction into electricity.

In a 2^{nd} aspect of the 1^{st} example embodiment, the compression laser array is configured to emit simultaneous laser pulses having a collective energy of at least 1 kilojoule over a pulse duration of at least 10 nanosecond. The remaining features and example features of the device are as described above with respect to the 1^{st} aspect.

In a 3^{rd} aspect of the 1^{st} example embodiment, the accelerating laser array is configured to emit simultaneous laser pulses having a collective energy of at least 1 kilojoule over a pulse duration of less than 10 nanoseconds. The remaining features and example features of the device are as described above with respect to the 1^{st} through the 2^{nd} aspects.

In a 4^{th} aspect of the 1^{st} example embodiment, the compression laser array comprises at least four lasers. The remaining features and example features of the device are as described above with respect to the 1^{st} through the 3^{rd} aspects.

In a 5^{th} aspect of the 1^{st} example embodiment, the ion acceleration laser array comprises at least four lasers. The remaining features and example features of the device are as described above with respect to the 1^{st} through the 4^{th} aspects.

In a 6^{th} aspect of the 1^{st} example embodiment, the accelerating laser array is configured to emit a pulse of at most 1 nanosecond. The remaining features and example features of the device are as described above with respect to the 1^{st} through the 5^{th} aspects.

In a 7^{th} aspect of the 1^{st} example embodiment, the ion acceleration laser array produces at least one beam at 190 nm to 550 nm. For example, the acceleration laser array can comprise individual lasers producing wavelengths between 190 and 550 nm. The shortest wavelengths can be produced by electron beam or discharge-pumped gaseous excimer lasers operating at their fundamental modes: ArF at 193 nm and KrF at 248 nm. The wavelengths of 505 and 353 nm can be produced by diode-pumped solid state lasers that have been frequency doubled or tripled using commercially available potassium dihydrogen phosphate (KH₂PO₄, KDP) nonlinear conversion crystals. The remaining features and example features of the device are as described above with respect to the 1^{st} through the 6^{th} aspects.

In a second example embodiment, the present invention is a nuclear fusion reaction fuel target. In a 1^{st} aspect of the 2^{nd} example embodiment, the fuel target comprises at least hydrogen and boron-11 nuclear fusion reactant materials, wherein the fuel target is spherical, and wherein the fuel target is solid at room temperature.

In a third example embodiment, the present invention is a nuclear fusion reaction fuel target. In a 1^{st} aspect of the 3^{rd} example embodiment, the fuel target comprises a core comprising at least boron-11 and a second nuclear fusion reactant material; and a shell encapsulating the core. The fuel target is solid at room temperature. In certain aspects of the 3^{rd} example embodiment, the shell can comprise at least a third nuclear fusion reactant material.

In a 2^{nd} aspect of either the 2^{nd} example embodiment or the 3^{rd} example embodiment, the fuel target further comprises an additional layer encapsulating the shell, the additional layer comprising a high atomic number (Z) material. The remaining features and example features of the device are as described above with respect to the 1^{st} aspect.

In a 3^{rd} aspect of either the 2^{nd} example embodiment or the 3^{rd} example embodiment, the second and the third nuclear fusion reactant material is each independently selected from a hydrogen-containing material, a deuterium-containing material, a tritium-containing material, a boron-11-containing material, a helium-3-containing material or a lithium-6-containing material. The remaining features and example features of the device are as described above with respect to the 1^{st} through the 2^{nd} aspects of the 2^{nd} or the 3^{rd} example embodiments.

In a 4^{th} aspect of either the 2^{nd} example embodiment or the 3^{rd} example embodiment, the fuel target comprises the high Z material is Al, Si, Ti, Cr, Fe, Co, Ni, Cu, Zn, Mo, Au, Pd or Pt. The remaining features and example features of the device are as described above with respect to the 1^{st} through the 3^{rd} aspects of the 2^{nd} or the 3^{rd} example embodiments.

In a 5^{th} aspect of either the 2^{nd} example embodiment or the 3^{rd} example embodiment, the fuel target has a characteristic size from about 2.5 micrometers to about 50 millimeters. For example, the fuel target can be approximately spherical, having the diameter equal to the characteristic size. The remaining features and example features of the device are as described above with respect to the 1^{st} through the 4^{th} aspects of the 2^{nd} or the 3^{rd} example materials.

In a fourth example embodiment, the present invention is a nuclear fusion system. In a 1^{st} aspect of the 4^{th} example embodiment, the nuclear fusion system comprises a nuclear fusion device according to any of the aspects of the 1^{st} example embodiment; and a nuclear fusion reaction fuel target according to any of the aspects of either the 2^{nd} example embodiment or the 3^{rd} example embodiment.

In a 2^{nd} aspect of the 4^{th} example embodiment, the system is configured to generate at least 2×10¹⁶ α-particles per kilojoule of energy delivered by a combination of a pulse of the compression laser array and a pulse of the ion acceleration laser array.

In a 3^{rd} aspect of the 4^{th} example embodiment, the nuclear fusion reaction fuel target is non-cryogenic. As used herein, a “non-cryogenic” refers to temperatures at or above 20 K.

In a fifth example embodiment, the present invention is a method for producing a nuclear fusion reaction. In a 1^{st} aspect of the 4^{th} example embodiment, the method comprises: irradiating a fuel target housed in a reaction chamber with laser pulses generated by a compression laser array, thereby compressing the fuel target, irradiating the fuel target with laser pulses generated by an ion acceleration laser array, thereby ionizing at least a portion of the fuel target, generating ions, accelerating the ions through the fuel target, and thereby igniting the nuclear fusion reaction; and converting energy released by the nuclear fusion reaction into electricity.

In a 2^{nd} aspect of the 5^{th} example embodiment, the compression laser array is configured to emit simultaneous laser pulses having a collective energy of at least 1 kilojoule over a pulse duration of at least 10 nanoseconds. The remaining features and example features of the device are as described above with respect to the 1^{st} aspect.

In a 3^{rd} aspect of the 5^{th} example embodiment, the accelerating laser array is configured to emit simultaneous laser pulses having a collective energy of at least 1 kilojoules over a pulse duration of less than 10 nanoseconds. The remaining features and example features of the device are as described above with respect to the 1^{st} through the 2^{nd} aspects.

In a 4^{th} aspect of the 5^{th} example embodiment, the accelerating laser array is configured to emit a pulse of at most 1 nanosecond. The remaining features and example features of the device are as described above with respect to the 1^{st} through the 3^{rd} aspects.

In a 5^{th} aspect of the 5^{th} example embodiment, the method further comprises a step of compressing the fuel target to at least twice its room-temperature density. The remaining features and example features of the device are as described above with respect to the 1^{st} through the 4^{th} aspects.

In a 6^{th} aspect of the 5^{th} example embodiment, wherein the ion acceleration laser array produces at least one beam at 190 nm to 550 nm. The remaining features and example features of the device are as described above with respect to the 1^{st} through the 5^{th} aspects.

### EXEMPLIFICATION

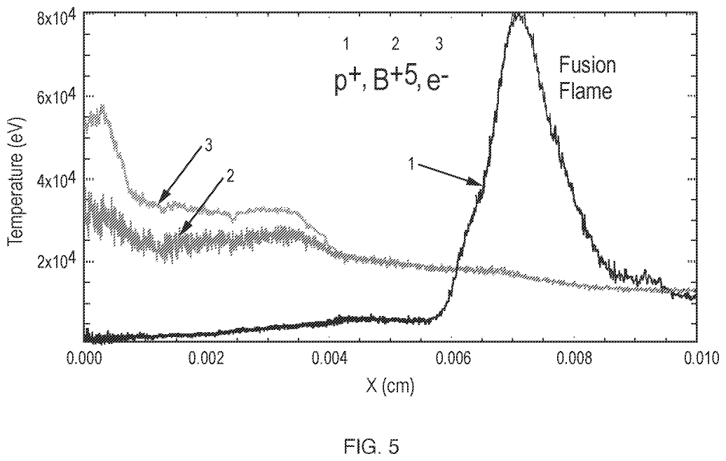

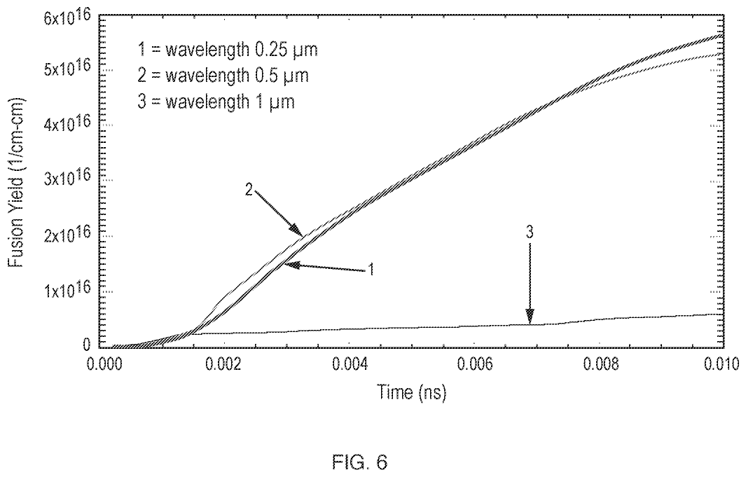

A computational simulations modelling of the proton-boron 11 reaction was conducted and the results are presented in FIG. 5 and FIG. 6.

The data shown in these figures was generated by computer simulations using the Chicago code (available at https://www.vosssci.com/products/chicago/chicago.html) from Voss Scientific. These simulations were performed in 1-D (axial) geometry and had a symmetry boundary condition at 0.01 cm. The plasma was a 50:50 mixture of H¹⁺ and B₁₁⁺⁵ at a density of 6.3×10²² per cubic centimeter. The plasma was irradiated by a laser with 0.25 μm wavelength and an intensity of 1×10²⁰ W/cm² 1 ps pulse. The simulations included Bremsstrahlung radiation losses. A hybrid algorithm in Chicago was used such that all particles started with kinetic descriptions, but after the laser turns off, kinetic electrons were allowed to transition to fluid description. All energy exchange interactions between particles were included, including those with alphas produced by fusion.

FIG. 5 is a plot generated by a simulation using the Chicago Code showing the generation of a non-equilibrium fusion flame that has propagated approximately 70 um into a boron-hydrogen target ˜4.5 ps after the 1×10²¹ W/cm² high intensity laser pulse was applied. The electron (3) to proton temperature (1) ratio is 0.2 which demonstrates a non-equilibrium fusion burn. The simulation also shows that the boron (2) and electron temperatures (3) have equilibrated, that fusion flame has an 80 keV proton peak, along with 16 keV electrons, such that the fusion energy production exceeds the radiation losses. This shock propagates at 10000 km/s (0.03 c) and persists for 15 ps in target for these parameters. A non-equilibrium thermonuclear flame is indicated by the peak from the black line (ion temperature) relative to electron temperature (red line) between approximately X=0.006-0.009 cm.

FIG. 6 is a plot generated by the same computer simulation used for FIG. 5 of the total fusion yield following a laser pulse of energy 4×10²⁰ W/cm² across wavelengths 0.25 μm (1), 0.50 μm (2) and 1 μm (3). The figure shows that the 1 micron laser generates negligible fusion burn, while the 0.25 and 0.5 micron lasers generate about the same level of fusion burn from a propagating fusion flame. The data in FIG. 6 indicates that 600 nm and below represent an optimal wavelength where fusion yields are maximized. These wavelengths could be achieved using excimer lasers or the non-linear conversion of the principal laser wavelength, which only act to reduce wavelength, and is well established approaches.

In example embodiments, the present invention can be understood with reference to the following numbered embodiments:
1. A nuclear fusion device, comprising: a reaction chamber configured to house a fuel target; a compression laser array configured to irradiate and thereby compress the fuel target; an ion acceleration laser array configured to irradiate the fuel target, to ionize at least a portion of the fuel target and generate ions, to accelerate the ions through the fuel target, and to thereby ignite a nuclear fusion reaction; and an energy conversion module, configured to convert energy released by the nuclear fusion reaction into electricity.
2. The device of embodiment 1, wherein the compression laser array is configured to emit simultaneous laser pulses having a collective energy of at least 1 kilojoule over a pulse duration of at least 10 nanosecond.
3. The device of any one of embodiments 1 or 2, wherein the accelerating laser array is configured to emit simultaneous laser pulses having a collective energy of at least 1 kilojoule over a pulse duration of less than 10 nanoseconds.
4. The device of any one of embodiments 1-3, wherein the compression laser array comprises at least four lasers.
5. The device of any one of embodiments 1-4, wherein the ion acceleration laser array comprises at least four lasers.
6. The device of any one of embodiments 1-5, wherein the accelerating laser array is configured to emit a pulse of at most 1 nanosecond.
7. A nuclear fusion reaction fuel target, comprising: a core comprising at least a first and a second nuclear fusion reactant materials; and a shell encapsulating the core, the shell comprising at least a third nuclear fusion reactant material.
8. The fuel target of embodiments 7, further comprising an additional layer encapsulating the shell, the additional layer comprising a high atomic number (Z) material.
9. The fuel target of any one of embodiments 7 or 8, wherein the first, the second, and the third nuclear fusion reactant material is each independently selected from a hydrogen-containing material, a deuterium-containing material, a tritium-containing material, a boron-1-containing material, a helium-3-containing material or a lithium-6-containing material.
10. The fuel target of any one of embodiments 8-10, wherein the high Z material is Al, Si, Ti, Cr, Fe, Co, Ni, Cu, Zn, Mo, Au, Pd or Pt.
11. The fuel target of any one of embodiments 7-10, wherein the fuel target has a characteristic size from about 2.5 micrometers to about 50 millimeters.
12. A nuclear fusion system comprising: a nuclear fusion device of any one of embodiments 1-6; and a nuclear fusion reaction fuel target of any one of embodiments 7-11 disposed in the reaction chamber of the nuclear fusion device.
13. The system of embodiments 12, configured to generate at least 2×10¹⁶ α-particles per kilojoule of energy delivered by a combination of a pulse of the compression laser array and a pulse of the ion acceleration laser array.
14. A method for producing a nuclear fusion reaction, comprising: irradiating a fuel target housed in a reaction chamber with laser pulses generated by a compression laser array, thereby compressing the fuel target; irradiating the fuel target with laser pulses generated by an ion acceleration laser array, thereby ionizing at least a portion of the fuel target, generating ions, accelerating the ions through the fuel target, and thereby igniting the nuclear fusion reaction; and converting energy released by the nuclear fusion reaction into electricity.
15. The method of embodiments 14, wherein the compression laser array is configured to emit simultaneous laser pulses having a collective energy of at least 1 kilojoule over a pulse duration of at least 10 nanoseconds.
16. The method of any one of embodiments 14 or 15, wherein the accelerating laser array is configured to emit simultaneous laser pulses having a collective energy of at least 1 kilojoules over a pulse duration of less than 10 nanoseconds.
17. The method of any one of embodiments 14-16, wherein the accelerating laser array is configured to emit a pulse of at most 1 nanosecond.
18. The method of any one of embodiments 14-17, further comprising a step of compressing the fuel target to at least twice its room-temperature density.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A nuclear fusion device, comprising:
a reaction chamber configured to house a fuel target;
a compression laser array configured to irradiate and thereby compress the fuel target;
an ion acceleration laser array configured to irradiate the fuel target, to ionize at least a portion of the fuel target and generate ions, to accelerate the ions through the fuel target, and to thereby ignite a nuclear fusion reaction; and
an energy conversion module, configured to convert energy released by the nuclear fusion reaction into electricity.

2. The device of claim 1, wherein the compression laser array is configured to emit simultaneous laser pulses having a collective energy of at least 1 kilojoule over a pulse duration of at least 10 nanosecond.

3. The device of any one of claim 1 or 2, wherein the accelerating laser array is configured to emit simultaneous laser pulses having a collective energy of at least 1 kilojoule over a pulse duration of less than 10 nanoseconds.

4. The device of any one of claims 1-3, wherein the compression laser array comprises at least four lasers.

5. The device of any one of claims 1-4, wherein the ion acceleration laser array comprises at least four lasers.

6. The device of any one of claims 1-5, wherein the accelerating laser array is configured to emit a pulse of at most 1 nanosecond.

7. The device of any one of claims 1-6, wherein the ion acceleration laser array produces at least one beam at 190 nm to 550 nm.

8. A nuclear fusion reaction fuel target, comprising:
at least hydrogen and boron-11 nuclear fusion reactant materials,
wherein the fuel target is spherical, and
wherein the fuel target is solid at room temperature.

9. A nuclear fusion reaction fuel target, comprising:
a core comprising at least boron-11 and a second nuclear fusion reactant material; and
a shell encapsulating the core,
wherein the fuel target is solid at room temperature.

10. The fuel target of claim 9, wherein the shell comprises at least a third nuclear fusion reactant material.

11. The fuel target of any one of claim 8 through claim 10, further comprising an additional layer encapsulating the shell, the additional layer comprising a high atomic number (Z) material.

12. The fuel target of any one of claims 8 through 11, wherein the second and the third nuclear fusion reactant material is each independently selected from a hydrogen-containing material, a deuterium-containing material, a tritium-containing material, a boron-11-containing material, a helium-3-containing material or a lithium-6-containing material.

13. The fuel target of any one of claims 8 through 12, wherein the high Z material is Al, Si, Ti, Cr, Fe, Co, Ni, Cu, Zn, Mo, Au, Pd or Pt.

14. The fuel target of any one of claims 8 through 13, wherein the fuel target has a characteristic size from about 2.5 micrometers to about 50 millimeters.

15. A nuclear fusion system comprising:
a nuclear fusion device of any one of claims 1-7; and
a nuclear fusion reaction fuel target of any one of claims 8-14 disposed in the reaction chamber of the nuclear fusion device.

16. The system of claim 1415 configured to generate at least 2×10¹⁶ α-particles per kilojoule of energy delivered by a combination of a pulse of the compression laser array and a pulse of the ion acceleration laser array.

17. The system of any one of claims 12-16, wherein the nuclear fusion reaction fuel target is non-cryogenic.

18. A method for producing a nuclear fusion reaction, comprising:
irradiating a fuel target housed in a reaction chamber with laser pulses generated by a compression laser array, thereby compressing the fuel target;
irradiating the fuel target with laser pulses generated by an ion acceleration laser array, thereby ionizing at least a portion of the fuel target, generating ions, accelerating the ions through the fuel target, and thereby igniting the nuclear fusion reaction; and
converting energy released by the nuclear fusion reaction into electricity.

19. The method of claim 20, wherein the compression laser array is configured to emit simultaneous laser pulses having a collective energy of at least 1 kilojoule over a pulse duration of at least 10 nanoseconds.

20. The method of any one of claim 18 or 19, wherein the accelerating laser array is configured to emit simultaneous laser pulses having a collective energy of at least 1 kilojoules over a pulse duration of less than 10 nanoseconds.

21. The method of any one of claims 18-20, wherein the accelerating laser array is configured to emit a pulse of at most 1 nanosecond.

22. The method of any one of claims 18-21, further comprising a step of compressing the fuel target to at least twice its room-temperature density.

23. The method of any one of claims 18-22, wherein the ion acceleration laser array produces at least one beam at 190 nm to 550 nm.
